(19) United States
(12) Patent Application Publication
(10) Pub. No.: US 2003/0063525 A1
(43) Pub. Date: Apr. 3, 2003

(54) Microprocessor controlled quartz analog clock movement

(76) Inventors: Ken Richardson, Gladstone, MO (US); Stan Richardson, Parkville, MO (US); Deborah Richardson, Gladstone, MO (US); Harold Wilcox, Gladstone, MO (US)

Correspondence Address: SPENCER, FANE, BRITT & BROWNE, 1000 WALNUT STREET, SUITE 1400, KANSAS CITY, MO, 64106-2140, US

(21) Appl. No.: 09/966,029

(22) Filed: Sep. 28, 2001

(51) Int. Cl. G04C 11/00; G04C 13/00

(52) U.S. Cl. 368/46

(57) ABSTRACT

A synchronous analog clock movement is provided for use in a secondary clock of a master-slave clock system. The movement keeps time independent of the master clock through a primary time base and a clock counter of a microprocessor. The movement is capable of receiving a time-correction signal from the master clock. The microprocessor controls a quartz movement motor. The microprocessor receives and recognizes the time-correction signal from the master clock, and then performs the time-correction process of advancing the movement to the correct position. The processor can keep time during a power failure through the use of a reserve power supply and secondary time base. Upon restoration of power, the processor will advance the quartz movement to the correct position. Optical sensors are connected to the microprocessor for determining the position of the hour and minute hands, or associated gearing, of the quartz movement.

### FIELD OF THE INVENTION

This invention relates to clock movements, and more particularly to secondary clock movements for use in synchronous analog clock systems of the type including a master clock and a plurality of secondary clocks that are time-corrected by the master clock.

### BACKGROUND OF THE INVENTION

There are a number of time system secondary correcting clock movements available today that are designed to be corrected periodically by a master clock and which keep time independent of the master clock. This master-slave time system is commonly used in schools and industrial environments where it is important to maintain synonymous time at a plurality of independent locations within a building. Almost all such time system correcting clocks use some variation of a brass mechanical (“Hanson”) movement for timekeeping and correction operations within the secondary clock.

The Hanson movement is a synchronous motor driven, mechanical movement comprised of gears, detents, clutches, and a correction electromagnet with a sector gear attached. The brass gears of the Hanson movement are mounted without bearings on steel shafts between two brass plates (front and back plates). The motor usually operates continuously off of a 120 volt alternating current at a speed of one revolution per minute. Appropriate gearing is driven by the motor to keep proper time on the clock by advancing the second hand at one revolution per minute, the minute hand at one revolution per hour, and the hour hand at one revolution per twelve hours.

One problem with the Hanson movement is that the motor and gearing is relatively inefficient, drawing about six to eight watts of power, depending upon the model. Another disadvantage is that the movement has a rather limited life expectancy, and requires a considerable amount of maintenance. As with most mechanical movements, there are many points on the brass back and front plates of the movement that wear out as a result of the steel shafts used for mounting the gears, and because of the lack of bearings. Also, since these movements are in time system secondary clocks in class rooms or an industrial environment, dust and dirt tend to accumulate on the movement surfaces, requiring periodic maintenance and reducing movement life expectancy. In the field, these movements have a life expectancy ranging from six months to several years depending upon manufacturing quality and operation maintenance. The motors themselves rarely go bad, but the entire movement, including the motor, is usually replaced as a unit. Therefore, the cost of a replacement unit, including installation, is excessive, usually approaching the cost of a new clock.

Because each secondary clock keeps time independently, it is common that an individual secondary clock will come out of sync with the other clocks in the system. Therefore, the master clock will periodically initiate a time-correction signal that places the Hanson movement into a time-correction. The time-correction signal from the master clock is usually a timed pulse that energizes the solenoid (electromagnet) of the Hanson movement. The solenoid operates the sector gear which operates one or several detents depending upon the length of travel of the sector gear. The length of travel of the sector gear is controlled by the time-length of the pulse from the master clock. A shorter pulse results in operation of a first detent which activates corrective gearing to rotate a single revolution at a rate of one revolution per minute. The corrective gearing will pick up the minute hand during its rotation to drive the minute hand to a predetermined location (master-position). A longer pulse results in operation of both the first and the second detents. This activates the gearing that drives the minute hand at a rate of one revolution per minute. Upon operation of the second detent, the minute hand will continue to operate at the accelerated rate until both the hour and minute hands have reached a predetermined position. In this manner the hour hand will advance at a rate of one revolution per twelve minutes until is has reached the master-position.

The most common correction format is the Simplex Time Recorder 59^{th} minute format. Under this type of correction an eight second pulse is sent from the master clock to the secondary clock every hour starting at fifty-seven minutes and fifty-four seconds. The eight second pulse is sufficient to energize the solenoid to move the sector gear to a position that operates the first detent (it takes about six seconds to activate the first detent). As discussed above, upon operation of the first detent, gearing is activated to advance the minute hand at one revolution per minute. The gearing will rotate one entire revolution where it will then be retained by the first detent. Upon completion of the revolution, the minute hand will be at fifty-nine minutes, where it will then continue to advance at its normal rate of one revolution per hour. This will set the clock to the correct time if it is less than one hour slow. If the clock is more than one hour slow, or if the clock is fast, the minute reading will be correct on the clock, but the hour will be incorrect upon completion of this hourly correction.

Under the Simplex Time Recorder format there is a twelve hour correction that is initiated at approximately 5:58 AM and 5:58 PM each day (actually at 5:57:54). The twelve hour correction involves a fourteen second pulse from the master clock to the secondary clock. As discussed above, after about six seconds of the pulse the solenoid and sector gear combination will have activated the first detent. The longer pulse will allow the solenoid and sector gear combination to activate a second detent which will hold the first detent in an open position until the hour and minute hands are brought to read 5:59. As discussed above, the hour gear will advance at a speed of one revolution every twelve minutes during this correction. Thus, if the clock reads 6:30 upon initiation of the correction, it will take twelve minutes for the clock to read 5:59. The actual time will be 6:10, resulting in the clock being eleven minutes slow. The clock will remain eleven minutes slow until the next hourly correction starting at 6:57:54 and correcting to 6:59.

A major problem with the Hanson clock movement is the fact that the clock will stop during a power failure and not make up time until the master clock sends a correction-signal. This can result in the clock reading the incorrect minute for up one hour, and can result in the clock reading the incorrect hour for up to twelve hours when using the Simplex format.

The time-correction signal pulses can be sent from the master clock to the secondary clock via a wired input or through the use of a carrier current system. The wired input comprises a separate wire running from the master clock directly to the solenoid. In a carrier current system the master clock sends the time-correction signal pulses over the alternating current power lines of the secondary clock. This requires the use of a receiver to recognize the signal and activate the solenoid. A major problem occurs when the secondary clock is used within a carrier current time system. Any stray signals picked up by the receiver will activate the correction electromagnet (solenoid) causing it to make loud clicking noises or, at worst, lock the movement into correction when the stray signal equals or exceeds the system correction timing requirements (either 8 seconds or 14 seconds when using the Simplex format).

Several of the problems of the prior art movement could be solved with the use of a quartz movement. Quartz clocks have long life expectancy and use very little power. Nevertheless, quartz clocks are generally not used as secondary system clocks because there currently exists no way to control and interface the movement of a quartz time system to a master-slave time system, or to operate a quartz movement on 120 volt alternating current. This is because quartz clocks usually operate on batteries and have their own time base, which is a quartz crystal. The long term accuracy of a quartz clock is very bad as temperature variations an battery voltage affect crystal frequency. Usually, a one to two minute variation per month is expected in quartz movements. In a school, or even a Union industrial situation, this in not acceptable. Therefore, it would be desirable to develop a method of controlling a quartz movement for use in conjunction with a master-slave clock system.

### SUMMARY OF THE INVENTION

An object of the instant invention is to provide an improved secondary clock movement for use in a master-servant clock system that overcomes the disadvantages of the prior art. Another object of the instant invention is to provide an improved secondary clock movement that operates to keep time independent of a master clock and which is capable of receiving a correction-signal from the master clock to initiate a time-correction process. It is yet another object of the instant invention to provide an improved secondary clock movement that performs the same or similar time-keeping and correction functions as the prior art mechanical movements through the use of a microprocessor control system. One other object of the instant invention is to provide a microprocessor controlled clock movement that can provide functions that are not available with the prior art mechanical movements, such as time correction/make-up immediately after a power failure without the use of a time-correction signal from the master clock or the use of any batteries. Another object of the instant invention is to provide a replacement clock movement that includes the combination of a mechanical Quartz movement and the controlling electronics on one printed circuit board with the same mounting points as the existing mechanical Hanson movements.

The above objects are achieved through the use of a processor controlled movement that can be placed within a clock housing, or behind a clock face, and attached to clock hands for timekeeping. The processor includes a clock counter to keep time within the secondary clock that is independent from the master clock. The processor advances a drive movement (or drive motor) in correspondence to the clock counter. The processor is connected to a correction-signal input. The correction signal input receives a signal from a master clock, the processor recognizes the signal as indicating that the secondary clock movement should be in a master-position. The processor performs a check on the movement position to see if it is in the master-position through the use of position sensors connected to the processor and associated with gearing in the drive motor. If the movement is not in the master-position, the processor will drive the movement at a high speed to the master-position. The processor will also determine the amount of time that was required to drive the movement from its initial position to the master-position and forward the movement beyond the master-position by an amount corresponding to that time-increment.

The clock movement of the instant invention can be operated off of an AC or DC power source. If an AC power source is used, using the alternating current power line as a primary time base for the clock counter results in excellent accuracy. Alternatively, a quartz crystal can be used as the primary time base if a DC system is used.

As with the prior art, the correction signal input of the instant invention can include a direct wired input, or with the “stuffing” of the on board carrier current receiver, time signals can be accepted over the power line of the movement. Whether a direct wired input is used, or a carrier current input, the timing signals at the processor input will be identical; making the inventive movement transferable to any type of master clock system.

The use of a dust proof quartz movement provides long life expectancy without mechanical problem. As with any analog clock movement, the quartz movement of the instant invention includes gears that are driven by a motor. Most quartz movements include an hour hand and minute hand that are geared together such that the hour hand rotates at a rate one twelfth that of the minute hand. A second hand is usually driven by the motor independent of the minute and hour hands; this is so that the clock movement can be manually set without providing rapid advancement of the second hand. This independent gearing can lead to inaccuracy between the minute hand and the second hand which is undesirable. Therefore, the movement of the instant invention includes an idler gear to coordinate the movement of the minute and second hands, thus increasing accuracy. In the preferred embodiment, the microprocessor used to control the quartz movement motor directly, giving the ability to stop or run at any speed to accomplish whatever task is necessary. As is discussed above, a quartz clock usually contains its own time base, a crystal, which is powered by a battery as a power source. In such a clock the crystal controls the movement motor/drive coil. In the instant invention a battery is not used, power is supplied to the motor from the processor, bypassing or eliminating the quartz crystal control of the motor.

The microprocessor also allows rejection of any stray signals not meeting the system correction timing requirements. Any signals that do not meet the predetermined timing requirements will not initiate a “false” correction. This is because the microprocessor first recognizes the signal as a time-correction signal before initiating a correction, as opposed to the prior art which begins the correction process (energizing the solenoid and moving the sector gear) immediately while a signal is being received. The microprocessor can be programmed to receive virtually any type of time correction format. The time correction format used in the preferred embodiment of the instant invention is the Simplex format discussed above.

The preferred embodiment includes two position sensors for increased accuracy of the movement. Each sensor contains and emitter and a detector within a single housing. A minute sensor is associated with a gear in the quartz movement that drives with the minute hand, and an hour sensor is associated with the gear in the quartz movement that drives the hour hand. The emitters of the sensors are directed toward the respective gears. Reflective strips are placed on each gear to reflect a beam of light emitted by each sensor, respectively.

Accumulation of seconds during power failures while using very little power and no batteries is another great feature of the instant invention. This is accomplished through the use of a secondary/reserve time base and reserve power supply. A quartz crystal works as an acceptable secondary time base during power failures, and as a good primary time base when a DC power source is used for the system. By using a very low power microprocessor, a physically small, electrically large capacitor can be used to supply operating voltage to the microprocessor and crystal during power failures without the need for battery replacement or recharging. By using an electrically large capacitor and switching the microprocessor into a “protect” mode, the inventive clock movement has at least one hour of standby time keeping. In “protect” mode, the microprocessor disables all I/O ports and does nothing except count time and keep memory of a time-increment and check for restoration of power. Upon restoration of power the inventive movement will advance the quartz drive motor by an amount corresponding to the power-failure time-increment.

All of the components of the inventive clock movement can be mounting on a printed circuit board, including the motor, for easy “drop-in” mounting into a clock housing. Using the same mounting points as the Hanson movement, makes the instant invention an easy replacement for worn out movements.

Adding a jumperable option feature allows various functions, including test programs, to be executed by the microprocessor. One option advances the movement to a master-position and holds that position to allow hand installation and position correction. Another option disables any functions in process and “kill” the memory of the processor.

The use of a microprocessor to control the clock movement, allows the inventive movement to perform all of the same functions as the mechanical movements of the prior art, including timekeeping that is independent of a master clock, and time correction via a correction signal from the master clock. Additionally, the microprocessor can be programmed to perform functions that are unavailable to the prior art mechanical movement, such as immediate catch-up after power failures. Also, the mechanical movement is capable of advancing only to a single time for which it has been designed; alternatively, the microprocessor controlled movement of the instant invention can be advanced to any time desired with proper programming.

Cost of manufacturing the inventive movement should be lower than the Hanson movement because many expensive components, such as brass gears, and large drive coils, have been eliminated. Installation is about the same as the prior art, but the inventive movement has a longer life and lower power used. Additionally, the movement of the instant invention requires virtually no maintenance. Total power draw by this movement is about 1.0 watt at 120 volts and 0.09 watt when operating at twelve volts AC. Therefore total system cost, projected over the life of the system will be less and better time keeping will be expected. The basic design also allows non-system operation, with all of the same features, except system correction, as the system clocks. This includes operation from the 120 volt power line (no batteries), making up time after power failure, and the AC line as a time base.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a diagram showing the primary components of the clock movement of the instant invention.

FIG. 2 is a circuit diagram of the clock movement of the instant invention.

### DESCRIPTION OF THE PREFERRED EMBODIMENT

Preferred embodiments of the present invention are hereinafter described with reference to the accompanying drawings.

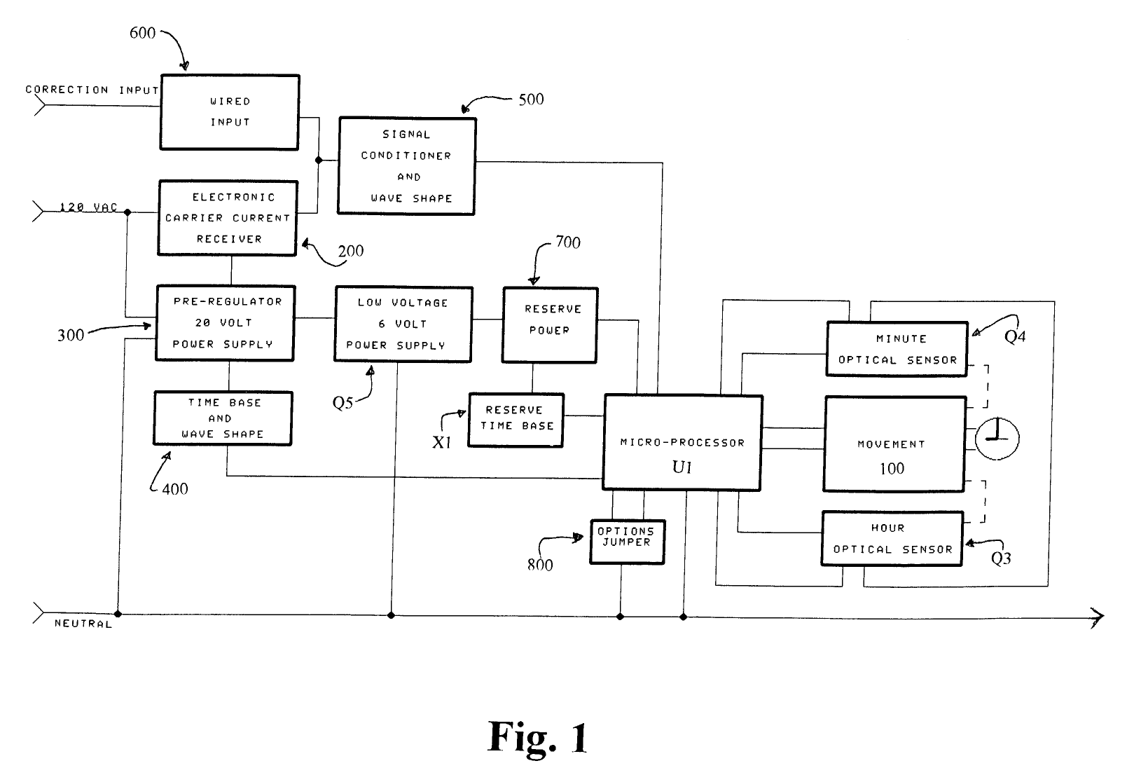

FIG. 1 is a diagram showing the primary components of the inventive clock movement that fits within the housing of an analog clock. All components mount to a single circuit board for easy installation and removal within the clock housing. The inventive movement operates the hands of the clock to keep time. The movement includes microprocessor U1, connected to movement motor 100, minute optical position sensor Q4, hour optical position sensor Q3, option jumper 800, reserve power supply 700, reserve time base X1, primary time base 400, and signal conditioner 500. Additional components include either wired input 600 or carrier current receiver 200 (or both) which are connected to signal conditioner 500. The clock movement also includes voltage pre-regulator 300, which connect to primary time base 400 and low voltage power supply Q5. Power supply Q5 connects to reserve power supply 700.

Microprocessor U1 has an internal, non-erasable program, that can make decisions based upon varying criteria supplied to its input ports, respond to the input with varying outputs to drive motor 100 of a quartz movement as needed, light various signals as indicators to the user or service personnel, and yet keep accurate time based upon an alternating current power line as a primary time base 400. Additionally, microprocessor U1 includes a crystal reserve, secondary time base X1, when AC power is not available. Secondary time base X1 is powered by reserve power supply 700 (made up of capacitors C2, C5, and C12). Also included is carrier current receiver 200 that can detect and decode correction signals sent over the AC power line by the system master clock to all secondary clocks or a printed circuit mounted terminal (wired input 600) by which wired correction signals are carried by direct wires from the master clock to the secondary clock. All of this is mounted on a single printed circuit board.

Rectifier and pre-regulator 300 is also mounted to the circuit board which drops the 120 volt AC power line to +20 volts which feeds low voltage regulator Q5 and the carrier current receiver, if stuffed. If the receiver is not stuffed, wired input 600 comprises two terminals that are provided to accept wired correction signals. Terminal AS=120 is for correction signals greater than 60 volts either AC or DC (direct current), and terminal AS−24 is for correction signals less than 60 volts either AC or DC. The carrier current receiver output and the wired correction output are summed into level shifting device (signal conditioner 500), then into the microprocessor. The microprocessor has an input level threshold of 1.5 volts at any input data pin and considers anything above this voltage as a “1” while anything lower is a “0”. All input interface devices have a level swing such that they are either 0 or +5 volts DC. The exception to this is the two inputs from the minute hand set knob strip detector (Q4) and the hour gear strip detector (Q3). These are analog inputs, meaning they may be any voltage from 0 to +5 volts DC; however, the 1.5 volt threshold still applies. Thus, any voltage less than 1.5 volts DC is a “0” and any voltage greater than 1.5 volts DC is a “1” within the microprocessor. The hysteresis is extremely small.

During normal operation, the AC power line is used as a time base for the microprocessor by counting the power line cycles. A standard 120 volt AC power line has a frequency of 60 hertz. Thus sixty line cycles is equal to one second. Interface 400 to the power line level shifts down to the 0 to +5 volt swing, shapes the wave form from a sine wave to a square wave with a 50% duty cycle and sends it to the microprocessor internal clock counter. When sixty counts have passed, on “tick” is generated and passed to the motor of the movement. During a power failure, a crystal feeds the internal clock counter a time base signal while the microprocessor is put into a “safe” state where all functions are suspended except time keeping (i.e. the accumulation of “ticks”). The microprocessor and counter function is powered by a reserve power source made up of an electrically large capacitor. The crystal will continue to oscillate, and the counter will continue to count until the AC power returns, or until the capacitor is discharged.

When a system correction signal is received, decoded, recognized and accepted, the microprocessor activates infrared emitters of reflective sensors Q4 and Q5 that are associated with an hour gear and minute gear of the quartz movement and starts an internal second “tick” counter. These position sensing devices transmit an infrared beam of light to a reflective strip and look for a return of that light at a detector mounted within the same physical case. There is a reflective strip attached to the hour hand gear and the minute set knob to provide for the reflection of the light. When the respective detectors sense the reflective strip, a DC voltage is generated by the sensor and sent to the microprocessor. If a “1” is seen by the microprocessor, the strip is considered in the system correction position (master-position). When both strips are in the system correction position, the microprocessor turns off the infrared emitter and adds the number of seconds (“ticks”) that it took to get to the system correction point. The processor then resumes normal time-keeping operation.

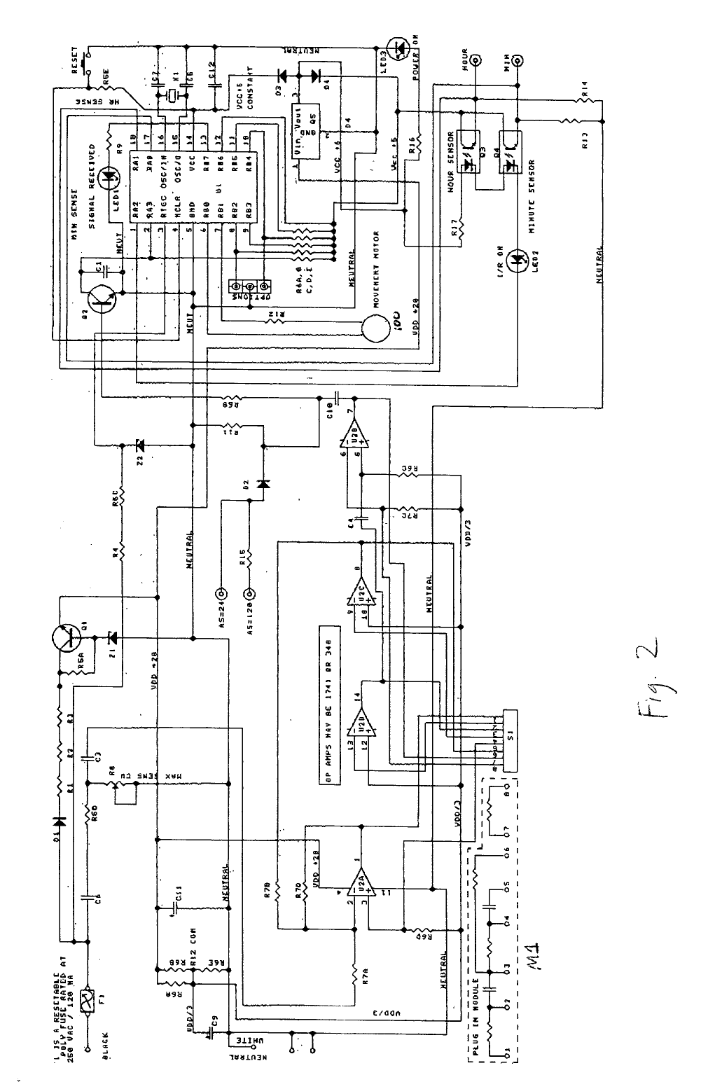

Referring to FIG. 2, a detailed circuit diagram of the inventive clock movement is presented. All voltages are measured with respect to Neutral. All resistors are 5% carbon film, ¼ watt rating except, R1, R2, and R3 witch are rated at 1 watt. Capacitors are individually marked. All power for Printed Circuit board operation is available through Poly Fuse F1 (TR250-120). Fuse F1 is a 250 volt, 120 milliamp, solid-state device capable of extremely fast switching, into a high resistance state. When the high current load is removed, the device resets and normal functions resume. Diode D1 (IN4007), R1, R2 and R3 (560 Ohm-1W) the main voltage dropping resistors, R5A (20K) the bias current supply for Z1, regulator Zener diode Z1 (20 volt), and high voltage NPN transistor Q1 (MPSA42) form the +20 volt pre-regulator 300. The main function of pre-regulator 300 is to drop the 120 volt AC line down to an output of +20 volts DC at the emitter of Q1 with respect to Neutral. Power for operation of the movement and the carrier current receiver split at this point. Power is routed to the carrier current receiver, if stuffed. Receiver 200 is comprised of U2A, U2C, U2D (LM348), R5D (20K), R8 (1K pot), R7A, R7B, R7D (1OK), R6A, R6B, R6D, R6E (4.7K), C11 (47M 25 volt, Electrolytic +/−20%), C9 (47M 25 volt, Electrolytic +/−20%), C6 (4700 pf, 5% Polyester cap), C3 (4700 pf, 5% Polyester cap), C4 (4700 pf, 5% Polyester cap), and a frequency select module M1. Frequency select module M1 plugs into socket S1 which is wired to the receiver circuit. The frequency select module plug-in allows the clock movement to be compatible with virtually any master-clock system. This receiver is a state variable bandpass filter, of which there are many variations commonly in use today. The output of this receiver is a signal fed into a fixed gain amplifier comprised of U2B (LM348), R7C (10K), R6C (4.7K), and coupled by C6 (4700 pf, 5% Polyester cap). The output of this amplifier is sent to a coupling capacitor C10 (4700 pf, 5% Polyester cap). This is used such that if the AC signal voltage exceeds a preset value, that voltage is sent to junction of R5B (20K) and R11 (51K) then to the base of the 2N4401 NPN transistor Q2. If the receiver is not stuffed, then the correction input is wired to wired input 600 (either AS−24 or AS=120). If AS=120 is used, it is sent to R15 (51K). The voltage from R15 (51K) and the AS=24 terminal are sent to the anode of D2 (1N4007). The cathode of D2 (1N4007) is connected to the capacitor C10 (4700 pf, 5% Polyester) and the 51K load resistor R11. The voltage, at this point, is coupled to R5B.

Signal conditioner 500 comprises resistor R5B (20K) which is connected to the base of Q2 (2N4401). Q2 is a level shifting NPN transistor that has a collector voltage, of +5 volts without a base signal and 0 volts when a base signal is present. Resistor R10A (100K) is connected as a pull-up resistor while capacitor C1 (1.0 microfarad, +/−20%, 50 volt electrolytic) filters out spikes or fast rise time signals. The junction of R10A (100K), C1 and the collector of Q2 (2N4401) are connected to microprocessor U1 pin 2, which is configured as an input. Q2 also provides isolation between the correction input and the CPU, U1. This is the time system correction signal input.

The 3 megohm resistor R4 is connected to the junction of F1 and the anode of D1. This point has a high voltage AC waveform of 120 volts RMS. Resistor R4 (3 meg) is connected to R5C (20K). R5C connected to the cathode of Z2. This also provides level shift to the microprocessor (U1) input pin 3 (RTCC or Timer 0, depending upon the version of the CPU used). This is then filtered and shaped into a 50% duty square wave which is used as the primary time base 400.

The low voltage, +5 volt regulated, power supply is used to operate the microprocessor (U1) and supporting interfaces to the CPU. It derives its power from the +20 volt regulated supply. Q5 is a 78L06 +6 volt current limiting, thermal limiting regulator. This regulated voltage is routed to current limiting resistor R16 (2K) and green LED3. This is the power on indicator. The output of Q5 (78L06) connects to diodes D3 (IN4007), D4 (1N4007), and 240 ohm resistor R17. Diode D4 (IN4007) supplies power for nonessential circuits operating on +5 volts. These are circuits not supported during a power failure. These connections are to the collector of the hour detector Q3 and minute detector Q4, resistor R6 pin 1 (100K), resistor R6E (20K), and microprocessor pin 12, configured as an input to monitor for power failures. Resistor R17 (240 ohm) is connected to the anodes of D3 (1N4007) and D4 (1N4007). The voltage at the connection of diodes D3 and D4 is +6 volts. The other end of resistor R17 (240 ohm) is connected to the anode of the infrared emitter of Q3 (EE-SY125). The cathode of Q3 is connected to the anode of Q4 (QRD-1114). The cathode of Q4 is connected to the anode of red LED2. The cathode of LED2 is connected to pin 1 of microprocessor U1, which is configured as an output. This means the emitters of devices Q3, Q4, and LED1 are turned on and off by the CPU (U1).

When the emitter of Q4 is activated, the detector side is looking for an infrared signal from the reflective strip attached to the minute set knob. When the strip is detected, a voltage is developed across resistor R13 (20K). One end of R13 is connected to the emitter of Q4 and CPU pin 17, configured as an input. The other end of R13 is connected to Neutral. This allows a variable voltage to be developed across R13 as the minute hand set knob approaches the 58^{th} minute position. When a threshold of 1.5 volts is reached at CPU pin 17, this is interpreted as a “1” or “on” by the CPU (U1). Any voltage less thin 1.5 volts is interpreted as a “0” or “off.”

When the emitter of Q3 (EE-SY125) is activated, the detector side is looking for an infrared signal from the reflective strip attached to the hour hand gear. When the strip is detected a voltage is developed across resistor R14 (100K). One end of R14 (100K) is connected to the emitter of Q3 (EE-SY125) and CPU pin 18, configured as an input. The other end of R14 (100K) is connected to Neutral. This allows a variable voltage to be developed across R14 (100K) as the hour hand gear approaches the 5:58 position. When a threshold of 1.5 volts is reached at CPU pin 18, this is interpreted as a “1” or “on” by the CPU. Any voltage less than 1.5 volts is interpreted as a “0” or “off.”

Diode D3 (1N4407) controls power for +5 volt supported operations. These include the microprocessor (U1), memory capacitor C12 (0.1 Farad, 5.5 volt, wet layer) and one end of pull up resistor R5E (20K). The other end of R5E is connected to a push button reset switch and the memory clear or reset (MCLR) pin of the CPU (U1). Components C2 (18 pf, 10%, disc ceramic), C5 (18 pf, 10%, disc ceramic), and X1 (32768 hertz crystal) are supported internally by the CPU. Capacitors C2 (18 pf) and C5 (18 pf) provide a stable load for crystal X1 (32768 hertz) during power failures.

Microproceescr (U1) pins 8, 9, 10, & 11 are configured as inputs and are pulled up to +5 volts by the 100K resistors R10B, R10C, R10D, and R10E. A three pin Berg jumper is used to select operational programs. The two outside pins select which program to execute while the center pin is connected to Neutral. Moving the jumper will connect one of the pins to Neutral (or low), depending up on the position selected. This is used as the options jumper allowing various programs to be executed within the CPU (U1).

Microprocessor U1 pin 13 is configured as an output and is connected to the 1 K resistor R9. The other end of R9 is connected to the yellow LED 1. LED 1 is used as an indicator that a correction signal is being received and processed by the CPU (U1). This LED is lit by power from the CPU while R9 limits the current to LED 1.

Pin 6 of the microprocessor (U1) is connected to the 82 ohm resistor R12. The other end of R12 (82 ohm) is connected to one side of Quartz movement motor 100. Pin 7 of the microprocessor (U1) is connected to other side of Quartz movement motor 100. Power to drive the movement is supplied by the CPU (U1) and current limited by resistor R12. When the CPU (U1) is driving the movement, one side will be held low (Neutral) while the other side is held high (+5 volts).

Power lines, in the USA, have a frequency 60 cycles per second. The preferred embodiment of the instant invention uses 56 AC line cycles for “off” time and 4 cycles of “on” time, for a total of 60 cycles, per 1 second of movement time cycle. This means that first both lines are low. Then one line (A) is pulled high while the other line (B) is held low for 4 AC line cycles of the cycle. Then both lines are held low for 56 AC line cycles. This comprises one “tick” or one second. Then line B is pulled up to +5 volts while line A held low for 4 AC line cycles. Then both lines are held low for 56 AC line cycles. This comprises one more “tick” or one second of movement time at normal speed.

The preferred embodiment of the instant clock movement utilizes the Simplex Time Recorder format. Essentially, under the Simplex format's 12 hour correction, the system is forced to 5:58 AM or PM. A 12 hour correction, under the Simplex Time Recorder format, is defined as a signal that begins at 5:57:54 and ends at 5:58:08 (a fourteen second pulse). Thus, upon recognition of the 12 hour correction signal, the instant invention forces the movement to advance to 5:58:08 AM or PM. When 12 hour correction has been received, and decoded by the CPU, the following happens: the CPU (U1) turns on LED2 and the emitters of Q4 (QRD-1114) and Q3 (EE-SY125). The infrared beam is projected towards the hour gear and the minute set knob. The movement is started by the CPU (U1), at high speed, moving towards 5:58:08. When the hour strip has been detected, the CPU starts looking for the minute strip. When the minute strip is detected, the CPU adds 10 “ticks” to the movement and then adds the number of seconds it took to advance the movement to 5:58:08 from where it was initially at the beginning of the correction. It then resumes normal speed. These 10 “ticks” are used to make sure we are not on the edge of the sensor range but closer to the center. If the movement is on time when the 12 hour correction is received, the strips are immediately detected and nothing happens.

Hourly correction as defined by the Simplex Time Recorder format, means the movement begins correction at the 58^{th} minute and is forced to the 59^{th} minute of the hour (correction signal begins at 57:54 and pulses for 8 seconds). Since the movement of the preferred embodiment can keep time without power for at least 1 hour this part of the format is not used. Nevertheless, this correction could be accomplished by the microprocessor in the event a reserve power supply and secondary/reserve time base is not utilized. Essentially, upon recognition of the hourly correction signal, which is an eight second pulse in the Simplex format, the inventive clock movement would advance to 58:02 of the hour.

When the microprocessor detects a power failure by a level shift from +5 volts to less than 1.5 volts at pin 1 of R10, and on pin 12 of U1, this results in the shut down of all microprocessor functions except time keeping and looking for the return of power. The CPU shifts from the AC line time base to an internal time base which uses the 32768 hertz crystal. Seconds are accumulated internally, theoretically up to 65536. This represents more than 12 hours, but since the memory capacitor C12 will only hold a charge for slightly more than 1 hour, only slightly more than 3600 seconds are accumulated before time keeping stops. If the capacitor loses its charge, a system reset occurs, and no time will be made up. When power is restored and detected by the microprocessor (U1) pin 12, and if C12 has held its charge, the CPU monitors the power failure detect pin 12 for 10 seconds to be sure it is stable. After the 10 second wait, the CPU starts sending high speed pulses to the motor of the movement causing it to advance at about 60 times faster than normal. The number of pulses sent is equal to the number accumulated seconds during the power failure plus the 10 during which the CPU monitored the power line. The amount of seconds required to send these pulses is also added at the end. The movement now will display the correct system time.

When the option jumper is moved to position 1 (left to center jumpered), this signals the microprocessor to advance the movement to 5:58:08 and stop. This is used to check the hand position, or for initial installation of the hands. Berg pin 1 is connected to R6B and to CPU (U1) pin 8, which is configured as an input. When the CPU detects a level of less then 1.5 volts on this pin, it sends pulses at high speed to the motor of the movement causing it to advance. The infrared emitter of Q3 and Q4, and LED2 are turned on and the detectors are monitored to determine when the strips come into view. When the hour gear strip is sensed, the minute hand set knob is checked. When that strip is detected, 10 “ticks” are added and the movement is stopped. CPU output pin is turned on and off at a half cycle rate, which causes the red LED 1 to flash. LED 1 will continue to flash until the jumper is moved from position 1. This emulates Simplex Time Recorder 12 hour correction.

When the option jumper is moved to position 2 (right to center jumpered), it pulls resistor R6D to Neutral causing CPU (U1) pin 10 to drop low. Since this is less than 1.5 volts, the microprocessor sees this as a low and the internal program recognizes this as a “kill memory” so that all ongoing functions or operations are stopped. Any other timing sequences are rejected.

Although the preferred embodiment of the inventive clock movement utilizes a PIC16C51 01/P microprocessor running at 32760 hertz, any suitable processor can be used. A suitable processor will include programmable ROM, enough RAM for dynamic control of the movement motor, and enough I/O ports to allow variables to be input and/or output when necessary. The included in the instant invention includes 12 I/O ports, has an external timing input, and runs on extremely low power.

The microprocessor of the instant invention keeps time during power failures by counting the number of seconds that have passed during the power failure. When power returns, pulses are sent to the drive motor at about 60 times the normal rate; however, the exact speed is not critical due to the fact that the processor also keeps track of the time-increment for advancement and adds sufficient pulses to the motor. Thus, an exact speed of 60 times normal operating speed is not critical.

Although the preferred embodiment of the instant invention utilizes 120 volt AC primary power source, the movement of the instant invention can be modified to operate on virtually any voltage including 48 volts, 24 volts, 12 volts or even as low as 6 volts by simply changing the value of a single resistor. Additionally, the inventive clock movement could be modified to operate on a DC voltage rather than AC. In such a situation, the quartz crystal would be used as both a primary and a secondary time base.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive clock movement is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention what is claimed as new and desired to be secured by letters patent is as follows:

1. An analog clock movement connectable to a power supply, said analog clock movement comprising:
a processor including a clock counter;
a correction-signal input connected to said processor;
a position sensor connected to said processor; and
a drive movement connected to said processor and associated with said position sensor.

2. The analog clock movement as claimed in claim 1 wherein said correction-signal input comprises a carrier current receiver.

3. The analog clock movement as claimed in claim 2 wherein said carrier current receiver comprises a plug-in frequency select module.

4. The analog clock movement as claimed in claim 1 wherein said correction-signal input comprises a wired input.

5. The analog clock movement as claimed in claim 1 wherein said correction-signal input comprises a carrier current receiver and a wired input.

6. The analog clock movement as claimed in claim 1 wherein said drive movement comprises a quartz movement motor.

7. The analog clock movement as claimed in claim 1 wherein the power supply comprises an alternating current.

8. The analog clock movement as claimed in claim 7 wherein said clock counter uses said alternating current as a primary time base.

9. The analog clock movement as claimed in claim 8 further comprising a quartz crystal associated with said clock counter as a secondary time base, and a reserve power supply connected to said crystal.

10. The analog clock movement as claimed in claim 1 further comprising a quartz crystal associated with said clock counter as a time base.

11. The analog clock movement as claimed in claim 1 further comprising a signal conditioner connected between said correction-signal input and said processor.

12. The analog clock movement as claimed in claim 1 further comprising a reserve power supply connected to said processor.

13. The analog clock movement as claimed in claim 12 wherein said reserve power supply comprises a capacitor.

14. The analog clock movement as claimed in claim 1 wherein said position sensor comprises an optical sensor.

15. The analog clock movement as claimed in claim 1 wherein said position sensor comprises a minute sensor and an hour sensor.

16. The analog clock movement as claimed in claim 1 further comprising an options jumper connected to said processor.

17. The analog clock movement as claimed in claim 1 further comprising a printed circuit board on which said processor, said position sensor and said drive motor are mounted.

18. The analog clock movement as claimed in claim 17 wherein said printed circuit board comprises clock-face mounting points.

19. The analog clock movement as claimed in claim 1 further comprising a system-status indicator connected to said processor.

20. The analog clock movement as claimed in claim 19 wherein said system-status indicator comprises at least one light emitting diode.

21. The analog clock movement as claimed in claim 1 further comprising a voltage regulator connected between said power supply and said processor.

22. A method of providing for time-correction of a secondary clock by a master clock including the steps of:
maintaining a clock counter within a secondary clock, said clock counter being independent of a master clock;
advancing a secondary clock movement in correspondence to said clock counter;
recognizing a time-correction signal generated by said master clock;
checking a movement position within said secondary clock in response to said time-correction signal;
comparing said movement position with a master-position indicated by said time-correction signal;
driving said movement to said master position upon an unequal comparison;
determining a time increment expended during said step of driving said movement to said master-position; and
forwarding said movement beyond said master-position by an amount corresponding to said determined time increment.

23. The method as claimed in claim 22 wherein said clock counter comprises a primary time-base and a secondary time-base.

24. The method as claimed in claim 23 further comprising the steps disabling said primary time-base and of maintaining said secondary time-base in the event of a power failure.

25. The method as claimed in claim 22 further comprising the steps of:
suspending said advancing, recognizing, checking, comparing, driving, determining and forwarding steps during a power failure; and
maintaining a memory for said clock counter during said power failure.

26. The method as claimed in claim 25 further comprising the steps of:
restoring said suspended operations upon restoration of power;
performing a memory test upon restoration of power; and
initiating advancement of said movement corresponding to said memory.

27. The method as claimed in claim 22 wherein said step of recognizing a time-correction signal comprises the steps of:
ignoring an hourly time correction signal; and
recognizing a twelve hour time correction signal.

28. The method as claimed in claim 22 further comprising the steps of:
suspending said maintaining, advancing, recognizing, comparing, determining and forwarding steps upon selection of a set-point option;
checking said movement position within said secondary clock;
comparing said movement position with a set-point position; and
driving said movement to said set-point position.

29. The method as claimed in claim 22 further comprising the steps suspending all functions upon selection of a disable option.

30. An analog clock movement connectable to a power supply, said analog clock movement comprising:
a processor including a clock counter; and
a quartz movement motor connected to said processor.

31. The analog clock movement as claimed in claim 30 further comprising a correction-signal input connected to said processor.

32. The analog clock movement as claimed in claim 30 further comprising a position sensor connected to said processor and associated with said motor.

33. The analog clock movement as claimed in claim 30 further comprising a primary and a secondary time base.

34. The analog clock movement as claimed in claim 33 further comprising a reserve power supply for said secondary time base.

35. The analog clock movement as claimed in claim 30 wherein said quartz movement motor comprises an idler gear connecting a minute hand gear to a second hand gear.

36. An analog clock movement connectable to a power supply, said analog clock movement comprising:
a processor including a clock counter;
a primary time base and a secondary time base associated with said clock counter;
a correction-signal input connected to said processor;
a position sensor connected to said processor; and
a drive movement connected to said processor and associated with said position sensor.

37. The analog clock movement as claimed in claim 36 wherein said primary time base comprises an alternating current and said secondary time base comprises a quartz crystal.

38. The analog clock movement as claimed in claim 36 wherein said primary time base and said secondary time base comprise a quartz crystal.

39. The analog clock movement as claimed in claim 36 further comprising a reserve power supply connected to said secondary time base.

40. A method of providing for time-correction of a secondary clock by a master clock including the steps of:
recognizing by a processor a time-correction signal;
determining by said processor if a clock movement is in a correct position;
initiating by said processor a high speed movement advancement upon an incorrect movement position;
terminating said high speed advancement upon a correct movement position.

41. The method as claimed in claim 40 further including the steps of:
ascertaining by said processor that said movement has reached a master-position; and
calculating by said processor a time increment expended during said high speed advancement to said master-position; and
forwarding said movement beyond said master-position by an amount corresponding to said calculated time increment.

42. An analog clock movement connectable to a power supply, said analog clock movement comprising:
a processor including a clock counter;
a correction-signal input connected to said processor;
a position sensor connected to said processor; and
a quartz drive movement connected to said processor and associated with said position sensor.

43. An analog clock movement connectable to a power supply, said analog clock movement comprising:
a processor including a clock counter;
a voltage pre-regulator connected to said processor;
a correction-signal input connected to said processor;
a position sensor connected to said processor; and
a drive movement connected to said processor and associated with said position sensor.
